(19) United States
(12) Patent Application Publication
(10) Pub. No.: US 2006/0098152 A1
(43) Pub. Date: May 11, 2006

(54) Display apparatus

(76) Inventors: Doo-soon Park, Suwon-si (KR); You-sub Lee, Gunpo-si (KR); Hyun-jun Jung, Suwon-si (KR); Kyung-kyun Lee, Seoul (KR)

Correspondence Address: STANZIONE & KIM, LLP, 919 18TH STREET, N.W., SUITE 440, WASHINGTON, DC, 20006, US

(21) Appl. No.: 11/229,553

(22) Filed: Sep. 20, 2005

(30) Foreign Application Priority Data
Nov. 5, 2004 (KR) 2004-89962

(51) Int. Cl. G02F 1/1345

(52) U.S. Cl. 349/149

(57) ABSTRACT

A display apparatus includes a display panel to display a picture, a PCB formed with a plurality of input terminals to supply an external signal to the display panel, a front cover and a rear cover to accommodate the display panel and the PCB and to form an external appearance, and a cover member including a plate provided between the PCB and the rear cover, coupled to one of the PCB and the rear cover, and covering a portion of the PCB on which the input terminals are positioned, and terminal exposing holes formed on the plate corresponding to a position of the input terminals to expose the input terminals externally with respect to the rear cover.

### CROSS-REFERENCE TO RELATED APPLICATIONS

This application claims the benefit under 35 U.S.C. §119 of Korean Patent Application No. 2004-89962, filed on Nov. 5, 2004, in the Korean Intellectual Property Office, the disclosure of which is incorporated herein in its entirety by reference.

### BACKGROUND OF THE INVENTION

1. Field of the Invention

The present general inventive concept relates to a display apparatus, and more particularly, to a display apparatus having an extra cover member which is coupled to input terminals.

2. Description of the Related Art

Generally, a display apparatus, such as a television, comprises a plurality of input terminals to receive a signal from an external apparatus, such as an extra speaker, a VTR (video tape recorder), and a DVD (digital video disk).

As shown in FIG. 1, a conventional display apparatus 101 is formed with a plurality of through holes 152 on a part of a rear cover 150 corresponding to a position and a shape of the input terminals 132. The input terminals 132 are exposed externally with respect to the rear cover 150 through the through holes 152.

In such a conventional display apparatus, the through holes for externally exposing the input terminals are formed directly on the rear cover, thereby generating assembly errors in a manufacturing process due to eccentricity of the through holes.

### SUMMARY OF THE INVENTION

Accordingly, the present general inventive concept provides a display apparatus having an extra cover member, which is coupled to input terminals.

Additional aspects and/or advantages of the present general inventive concept will be set forth in part in the description which follows and, in part, will be obvious from the description, or may be learned by practice of the present general inventive concept.

The foregoing and/or other aspects and advantages of the present general inventive concept are achieved by providing a display apparatus having a display panel to display a picture, a PCB formed with a plurality of input terminals to supply an external signal to the display panel, and a front cover and a rear cover to accommodate the display panel and the PCB and to form an external appearance, the display apparatus comprising a cover member comprising a plate provided between the PCB and the rear cover, coupled to one of the PCB and the rear cover, and covering a portion of the PCB on which the input terminals are positioned, and terminal exposing holes formed on the plate corresponding to a position of the input terminals to expose the input terminals externally with respect to the rear cover.

The rear cover may comprise a penetrating portion provided at a position corresponding to the cover member.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a rear perspective view of a conventional display apparatus;

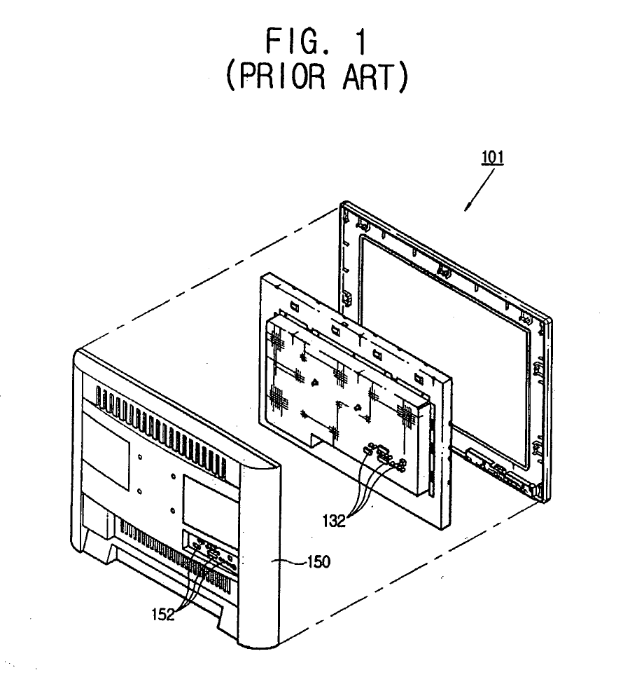

FIG. 2 is a rear exploded perspective view illustrating a display apparatus according to an embodiment of the present general inventive concept;

FIG. 3 is a combined perspective view illustrating a cover member of the display apparatus of FIG. 2; and

FIG. 4 is a rear combined perspective view illustrating the display apparatus of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept while referring to the figures.

Hereinbelow, an LCD TV will be described as an example of a display apparatus in an embodiment of the present general inventive concept, but the general inventive concept is not limited thereto.

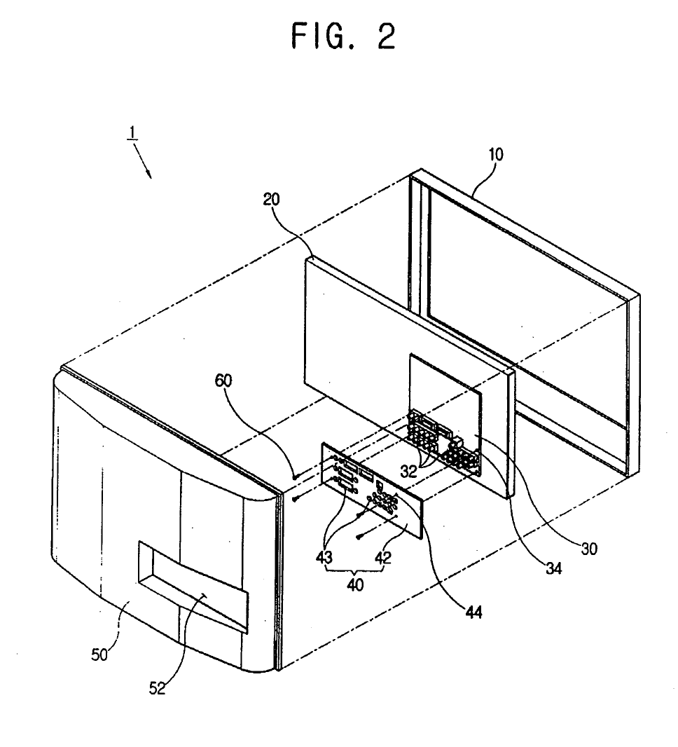

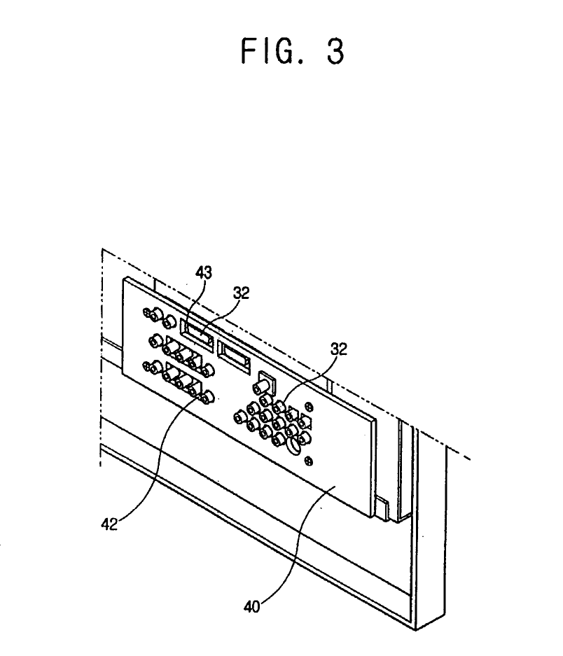

FIGS. 2 through 4 illustrate a display apparatus 1 according to an embodiment of the present general inventive concept. Referring to FIGS. 2 through 4, the display apparatus 1 comprises a display panel 20 to display a picture, a PCB 30 to transmit various signals to the display panel 20, and front and rear covers 10 and 50, respectively, to accommodate the display panel 20 and the PCB 30 and to form an external appearance of the display apparatus 1.

A plurality of input terminals 32 to receive signals from external apparatuses, such as a VTR, a DVD, etc., are provided at the PCB 30. Also, screw coupling parts 34 to couple with a cover member 40 (to be described later) can be formed on the PCB 30.

The input terminals 32 protrude from the PCB 30, and are disposed in various sizes and shapes corresponding to the external apparatuses, which can connect thereto. The input terminals 32 are exposed externally through the rear cover 50 to be connected with the external apparatuses. The cover member 40 is attached to the PCB 30 to expose the input terminals 32 only and to protect a portion of the PCB 30 surrounding the input terminals 32.

The cover member 40 comprises a plate 42 to cover the portion of the PCB 30 surrounding the input terminals 32. The plate 42 is formed with terminal exposing holes 43 having various sizes and shapes corresponding to the input terminals 32 of the PCB 30 to allow the input terminals 32 to protrude therethrough.

A plurality of screw accommodating parts 44 can also be formed on the plate 42 to couple with screws 60. The screws 60 accommodated in the screw accommodating parts 44 protrude through the plate 42 towards the PCB 30 and couple with screw coupling parts 34 formed on the PCB 30, which causes the cover member 40 to couple with the PCB 30.

When the cover member 40 is coupled to the PCB 30, the input terminals 32 are exposed through the plate 42 of the cover member 40 through the terminal exposing holes 43. The input terminals 32 and a portion of the cover member 40 are exposed externally through the rear cover 50.

A penetrating portion 52 is formed on the rear cover 50 corresponding to the position and the shape of the cover member 40.

The penetrating portion 52 accommodates the cover member 40 to expose the input terminals 32 exposed through the terminal exposing holes 43 of the cover member 40 and a portion of the plate 42 adjacent to the terminal exposing holes 43 externally through the rear cover 50. Accordingly, a user may connect the external apparatuses, such as the VTR, the DVD, etc., to the display apparatus 1 through the input terminals 32.

With this configuration, the coupling process of the cover member of the display apparatus according to the embodiment of the present general inventive concept is as follows.

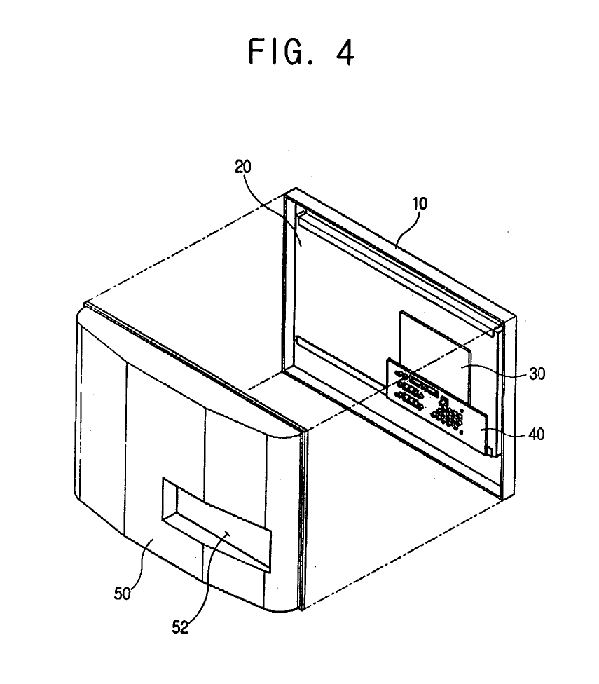

As illustrated in FIG. 4, the PCB 30 is connected to a back of the display panel 20 in a state in which the display panel 20 is coupled to the front cover 10.

The input terminals 32 disposed on the PCB 30 are exposed externally with respect to the display apparatus 1 and connect to the external apparatuses.

When the input terminals 32 are exposed externally, the portion of the PCB 30 surrounding the input terminals 32 is also exposed externally, and the cover member 40 is coupled to the PCB 30 to protect the portion of the PCB 30 surrounding the input terminals 32.

The terminal exposing holes 43 are formed on the plate 42 of the cover member 40 to corresponding to the input terminals 32. A portion of the plate 42 without the terminal exposing holes 43 covers the PCB 30 to prevent the PCB 30 from being exposed externally.

After the cover member 40 is coupled to the PCB 30, the rear cover 50 is assembled thereon. The penetrating portion 52 is formed on the rear cover 50 to expose a portion of the cover member 40 formed with the terminal exposing holes 43. As the terminal exposing holes 43 and the input terminals 32 accommodated therein are exposed by the penetrating part 52, a user may connect the external apparatuses to the input terminals 32. When the input terminals 32 are exposed externally, the PCB 30 is not exposed externally because the plate 42 of the cover member 40 protects the portion of the PCB 30 surrounding the input terminals 32.

The cover member 40, as described above, is illustrated as being coupled to the PCB 30. Alternatively, the cover member 40 may be coupled to the rear cover 50.

The cover member 40, as described above, is coupled to the PCB 30 by the screws 60, but the present general inventive concept is not limited thereto. Alternatively, the cover member 40 may be coupled to the PCB 30 by various coupling parts, such as a hook, a snap, etc.

Although input terminals 32 are described above, the present general inventive concept is not limited thereto, and may be applied to various other types of terminals.

The display apparatus 1, as described above, includes input terminals 32 exposed through a rear cover 50, but the present general inventive concept is not limited thereto. The input terminals 32 may alternately be exposed through the front cover 10 or various other surfaces of the display apparatus 1.

As described above, in a display apparatus according to the present general inventive concept, terminal exposing holes to expose input terminals are formed in a cover member and not directly formed on a rear cover, thereby reducing assembly errors in a manufacturing process due to eccentricity of through holes, and improving an external appearance of the display apparatus.

A cover member, according to the present general inventive concept, may be employed in a VTR, a DVD, a computer, or the like, as well as in a display apparatus, as described above, without departing from the principles and spirit of the general inventive concept.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus having a display panel to display a picture, a PCB formed with a plurality of input terminals to supply an external signal to the display panel, and a front cover and a rear cover to accommodate the display panel and the PCB and to form an external appearance, the display apparatus comprising:
a cover member comprising a plate provided between the PCB and the rear cover, coupled to one of the PCB and the rear cover, and covering a portion of the PCB on which the input terminals are positioned, and terminal exposing holes formed on the plate corresponding to a position of the input terminals to expose the input terminals externally with respect to the rear cover.

2. The display apparatus according to claim 1, wherein the rear cover comprises a penetrating part provided in a position corresponding to the cover member.

3. A display apparatus comprising:
a housing having an opening in a surface thereof;
a printed circuit board (PCB) disposed within the housing and having a plurality of connection terminals extending from the PCB through the opening; and
a cover member disposed between the opening and the PCB to prevent the PCB from being exposed externally with respect to the housing through the opening.

4. The display apparatus according to claim 3, wherein the cover member comprises:
a plate to prevent the PCB from being exposed to the opening; and
terminal exposing holes formed in the plate to allow the connection terminals to protrude through the plate.

5. The display apparatus according to claim 4, wherein a size and an arrangement of the terminal exposing holes correspond to a size and arrangement of the plurality of connection terminals.

6. The display apparatus according to claim 3, wherein the cover member is attached to one of the PCB and the surface of the housing.

7. The display apparatus according to claim 3, wherein a size of the opening corresponds to a size of the cover member and the opening accommodates the cover member therein.

8. A display apparatus, comprising:
a display panel;
externally exposed connection terminals to input an external signal;
a printed circuit board (PCB) connected to the connection terminals to transmit the input external signal to the display panel; and
a plate coupled to the PCB to prevent the PCB from being externally exposed and having a plurality of terminal exposing holes to accommodate the connection terminals therein such that the connection terminals are externally exposed.

9. A display apparatus comprising:
a housing formed with an opening in a surface thereof;
terminals exposed externally with respect to the housing through the opening; and
a cover member separately formed from the housing, disposed at the opening, and having through holes to accommodate the terminals therein and to allow the terminals to be externally exposed with respect to the housing through the opening.

10. An electronic apparatus, comprising:
a housing;
a printed circuit board (PCB) disposed within the housing and having input/output terminals protruding from the PCB through a surface of the housing; and
a plate disposed between the PCB and the surface of the housing and formed with terminal accommodating holes to allow the input/output terminals to protrude therethrough.

11. The electronic apparatus according to claim 10, wherein the plate is coupled to one of the PCB and the surface of the housing.

12. The electronic apparatus according to claim 10, wherein the housing comprises an opening formed in the surface thereof to accommodate the plate such that the plate and the input/output terminals protruding through the terminal accommodating holes of the plate are exposed externally with respect to the housing.

13. The electronic apparatus according to claim 12, wherein the plate prevents the PCB from being exposed externally with respect to the housing.
